(19) United States
(12) Patent Application Publication
(10) Pub. No.: US 2005/0125607 A1
(43) Pub. Date: Jun. 9, 2005

(54) Intelligent caching of working directories in auxiliary storage

(75) Inventors: Thomas E. Chefalas, Somers, NY (US); Steven J. Mastrianni, Unionville, CT (US)

Correspondence Address: Eric W. Petraske, 68 Old Hawleyville Road, Bethel, CT, 06801, US

(73) Assignee: INTERNATIONAL BUSINESS MACHINES CORPORATION, Armonk, NY (US)

(21) Appl. No.: 10/730,644

(22) Filed: Dec. 8, 2003

(51) Int. Cl. G06F 12/00

(52) U.S. Cl. 711/113

(57) ABSTRACT

A combination of non-rotating storage and associated software temporarily transfers storage functions from a hard disk to the non-rotating storage. This invention provides for the “on the fly” adaptation and transfer of an application's disk requirements to be instead sent to a flash storage, non-spinning memory device, solid state memory, or similar device while the hard drive is powered down. This not only makes operations faster, but results in a large savings in battery power.

### FIELD OF INVENTION

The present invention relates to a method and apparatus for the intelligent caching of working directories in auxiliary or temporary storage, in particular to battery-powered systems.

### BACKGROUND OF THE INVENTION

Today's computer systems rely heavily on disk access to load programs, store data and configuration information, and save files. Programs are so large that they often can't fit into usable physical memory and often are forced to run in logical memory partitions.

When a branch occurs in the program flow, the sequence of instructions may call on an instruction that is located on the disk and not in the RAM or cache memory. In that case, the program operation pauses while the disk turns. When the correct portion of the disk is read, the relevant segment of the program is read into RAM and execution resumes. Much effort has gone into the development of cache memory and of programming techniques to avoid excessive disk calls, but modem large programs still make very many calls to instructions or data that are not located in RAM or in the cache.

Programs such as Internet Explorer rely on the hard disk to cache hundreds, even thousands of files such as GIFs, JPGs, HTML pages, etc. This causes a great deal of disk activity, which not only is slow but uses a correspondingly large amount of battery power. Some programs create and use a large number of temporary files. All of this causes a great deal of disk activity, causing the hard drive to keep running or continuously spin up and down, wasting power and delaying operation of the program until the instructions or data are fetched from the disk.

In addition to technical reasons for the great amount of disk usage, there are also marketing considerations. Quite often, retailers will advertise computer systems with a minimal amount of RAM, though having very large capacity disk drives. The lack of RAM aggravates the problem of excessive disk usage because there can be less data and instructions stored in a smaller amount of RAM.

If the only computer systems affected were desk-top systems, the main drawback to these various trends would be slower performance of the programs being run. The trend to greater use of portable computer systems means that excessive disk calls translate very quickly to short battery life.

It is not realistic to expect that programmers will spend additional effort to shrink the size of the programs. It is a truism in programming that it takes longer to code a compact program than a bloated one. With present competitive pressures to introduce features and to bring out frequent upgrades, it is not realistic to expect that program vendors will shrink the size and storage demands of their products in the near future.

Methods of reducing disk access are known, such as cache memory, which employs relatively high power consumption integrated circuits. Other techniques could be used that would consume less power than conventional cache memory.

As mentioned above, the computer vendors ordinarily emphasize disk capacity in their advertising and not memory size.

Operating systems could take advantage of technical features of relatively low power alternatives to disk drives, such as flash memory or other solid state memory.

There is a chicken and egg problem in that the programmers of application programs will not spend the time to offer such features until a large fraction of systems have the memory devices to take advantage of the possibility of saving battery power and execution time and hardware vendors will not add to their base cost in a highly competitive market unless that extra cost can produce a benefit in battery life or program response that the consumer is willing to pay for.

Thus, there is a potential benefit to the consumer from a third-party offering of a combination of non-rotating hardware and associated software that will improve the performance of application programs without waiting for the application programmers and/or the operating system programmers to offer such features.

### SUMMARY OF THE INVENTION

The invention relates to a combination of non-rotating storage and associated software to temporarily transfer storage functions from a hard disk to the non-rotating storage.

This invention provides for the “on the fly” adaptation and transfer of an application's disk requirements to be instead sent to a flash storage, non-spinning memory device, solid state memory, or similar device while the hard drive is powered down. This not only makes operations faster, but results in a large savings in battery power.

### BRIEF DESCRIPTION OF THE DRAWINGS

FIG. 1 illustrates a block diagram of the present invention.

### DETAILED DESCRIPTION

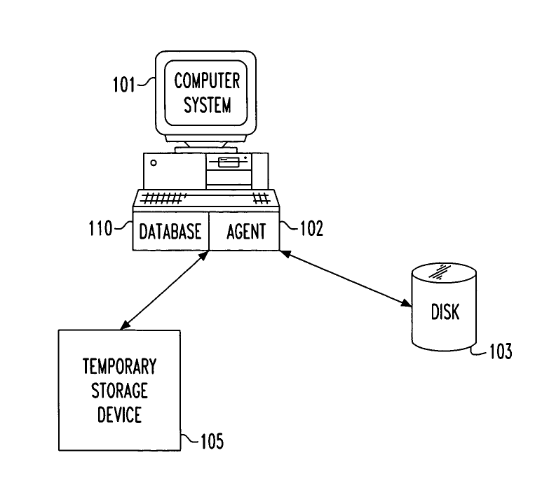

FIG. 1 illustrates in block diagram form a battery-powered computer system 101 having an auxiliary agent program 102 that will be described below. The computer labeled system 101 schematically includes the computer CPU, disk storage, RAM, and conventional caches. Hard disk drive 103 and temporary storage 105 are also shown.

The agent program 102 communicates with a database 103 that may be conveniently located in RAM or in temporary storage 105. The function of data base 110 is to keep track of the location of data and program segments that would ordinarily be placed on the hard drive.

In operation, large programs move segments of the program from the long-term storage on the hard drive into RAM, to improve access time. There is not enough room in RAM to hold many popular programs, plus the operating system and possibly other programs. Thus, the typical large application program (or, equivalently a portion of the operating system) will contain program language that recognizes when the application program needs data or instructions that are not in RAM or in the CPU cache and fetch the required information from the disk, while the program pauses.

The database 110 of the present invention is activated when the computer system 101 is started and immediately begins monitoring programs and the files associated with the programs.

When a program is started that creates or edits files, the associations between that program and the file or files it creates or edits is stored in an associative database as we have described in copending patent application Docket YOR8-2001-0031, incorporated herein by reference in its entirety. Such a database is required to maintain the association of an application to its files, without regard to the file type extension or naming method. Normally, an operating system such as Microsoft Windows keeps track of files as types by the value of the file extension, which is the group of characters following the rightmost “.” in the file name.

The database 110 according to the present invention maintains the association of files and programs in a separate system from the operating system.

The database provides an important link from the application through the database to the data files. If a temporary file or folder is created, that folder or file is associated with that application. When the application is closed, the contents of those files and folders in the temporary storage are written to the main hard disk storage. When the application is re-run, those temporary folders and files are created on behalf of the application in the temporary storage.

Subsequent access to the folders or files is made directly to the temporary storage. The contents of the temporary store are then written out to the hard disk when the program exits.

With this approach, the benefits of fast, low power storage may be realized without altering the operating system.

When the computer system 101 is started, the invention database agent 102 begins monitoring the computer system 101. When a program (e. g. an application program) is launched on computer system 102, the database agent 102 of the present invention begins monitoring the program and keeps track of its storage requests.

If the program has been previously started and has created files or folders, those files or folders are read from the hard disk database 103 and placed into the temporary storage device 105.

If the program has been written such that it creates (temporary) files or folders each time it is started, those files or folders are also placed into the temporary storage device 105.

The agent also copies program segments that are most frequently used (and are not in RAM or in the operating system's cache memory) from the hard drive to the temporary storage, using stored information kept by the program, if such information is available, or alternatively using its own records on the most-often used segments.

The invention then attempts to power down the hard disk drive in the computing system 101. If no other applications require the hard drive to be running, the drive may be powered down so that it is no longer rotating and using battery power.

The agent of the current invention 102 monitors the file system operations by installing an intercept hook into the operating system file functions. When it receives requests from the file system, the agent routes these requests to the temporary memory 105. It returns the status to the operating system, and the operating system thinks it has performed the operation to the actual hard disk drive. When the program is finished or ends, the hard disk drive is started, if necessary, and the contents of the temporary drive are reflected back to the actual hard drive. The temporary storage 105 is also initialized for reuse.

An important advantage of the present invention is that it does not require re-writing the disk handling portion of the operating system. Thus, the use of the invention is not contingent on a business decision by the operating system vendor.

If no space is available on the temporary storage 105 or in the course of operation the temporary storage device 105 becomes full, the hard disk drive is started, if necessary, and the contents of the temporary storage device 105 are written to the hard disk drive. Thus power savings are accomplished as the size of temporary storage permits, but the lack of temporary storage space will still allow applications to run, but without benefit of the power saving measures.

As a simple example of just a few uses of the invention, consider a word processor. When the program is first called during a work session, the computer operating system will load a portion of the program into RAM and into the computer's cache.

When the user starts work on a new document, the program stores the new text in RAM and, from time to time, backs up the work done to date on the temporary storage 105 instead of the hard drive. When the user inserts a mathematical symbol into a document or switches to a different font, the application program will attempt to fetch the required data. If the data are not in RAM, the operating system will try the cache and then call to the disk.

The agent will intercept the disk call and check if the relevant data have been loaded into the temporary storage. If the relevant symbol library and/or font definition have been used in the past fairly often, the agent will have loaded them into temporary storage 105 during the program setup for this work session and the program segment currently running in RAM will be automatically directed to temporary storage 105 instead of powering up disk 103, thus saving both the battery power and time required to bring the disk up to operating speed.

If the relevant data have not been pre-loaded, the agent will not interfere with the call by the program (operating system) to the disk, but will store the data retrieved in temporary storage 105. Conventional algorithms used in cache memory may be applied here to decide how much data in the vicinity of the data that is specifically required will be stored in temporary storage.

In the particular illustrated example, a user who calls up the Greek symbol “nu” may well also call up “pi” and “lambda”. Associative data may be kept in the database and stored between work sessions to build up a picture of this particular user's ordinary practices. Third party sources of information as to what features are most commonly used, such as the program vendor or the local IT department, may also be available.

The agent has been illustrated as being separate from the operating system. Those skilled in the art will appreciate that an agent according to the invention could also be incorporated into the operating system.

The instructions for the agent may be located on non-volatile storage, e.g. a disk, and copied into RAM; or the instructions could be stored in non-volatile solid state memory in the same hardware as the storage 105.

For convenience in the following claims, the term “data” will be used generally to cover both items such as the text in a word processor or the numbers in a spreadsheet and also the instructions that are part of an application program: i.e. the agent may store program segments and/or text or numbers in the temporary storage.

It should be noted that this invention is not a RAM disk, though it may make use of a RAM disk for the non-rotating storage. The technology for RAM disks, in which a portion of RAM is set up to emulate the structure of a disk, has been around for many years and is well understood.

The non-rotating storage 105 is preferably the storage in the system that consumes the least power. Alternatives to RAM are a network storage device, an SAN (storage area network) device, organic memory, EEPROM, flash memory and others.

Since the main function of the invention is saving power, the initial cost of the components in the storage 105 will weigh less in the mind of the user than the benefits of longer battery life.

Optionally, the agent may reformat the intercepted data being sent by the operating system to the hard drive. For example, if the operating system converts a text file to segments reflecting the physical structure of the disk, the agent may either store the data on storage 105 in the same format, or convert it to any other format that may be convenient. If the operating system sends out data in the same format that the application program uses and electronics on the disk drive formats the data as required by the disk, the agent may simply keep the format.

While the invention has been described in terms of a single preferred embodiment, those skilled in the art will recognize that the invention can be practiced in various versions within the spirit and scope of the following claims.

1. A computer system having a CPU, RAM and a hard disk drive further comprising:
non-rotating temporary storage means for storing data; and
agent means for intercepting calls to said disk drive and directing them to said non-rotating temporary storage when said disk drive is powered down, in which said agent means stores the contents of said temporary storage in said disk drive when said computer program is shut down.

2. A computer system according to claim 1, in which said agent copies temporary files generated by said program to said temporary storage.

3. A computer system according to claim 1, in which said agent is located in temporary non-rotating storage means other than RAM.

4. A computer system according to claim 1, in which said agent copies data to said temporary storage and thereafter directs commands to said hard disk drive to start and stop rotating, so that said hard disk drive is powered down and thereafter is rotated to store data under command of said agent only after an attempt to locate data in said temporary storage has failed.

5. A computer system according to claim 4, in which said agent copies temporary files generated by said program to said temporary storage.

6. A computer system according to claim 4, in which said agent is located in temporary non-rotating storage means other than RAM.

7. A computer system according to claim 1, in which said agent is located outside an operating system.

8. A method for operating a computer system having a CPU, RAM, non-rotating temporary storage means for storing data and a hard disk drive said method comprising the steps of:
intercepting calls to said disk drive by an agent and directing them to said non-rotating temporary storage when said disk drive is powered down, in which said agent means stores the contents of said temporary storage in said disk drive when said computer program is shut down.

9. A method according to claim 8, in which said agent copies temporary files generated by said program to said temporary storage.

10. A method according to claim 8, in which said agent is located in temporary non-rotating storage means other than RAM.

11. A method according to claim 8, in which said agent copies data to said temporary storage and thereafter directs commands to said hard disk drive to start and stop rotating, so that said hard disk drive is powered down and thereafter is rotated to store data under command of said agent only after an attempt to locate data in said temporary storage has failed.

12. A method according to claim 11, in which said agent copies temporary files generated by said program to said temporary storage.

13. A method according to claim 11, in which said agent is located in temporary non-rotating storage means other than RAM.

14. A method according to claim 8, in which said agent is located outside an operating system.

15. An article of manufacture in computer readable form comprising means for performing a method for operating a computer system having a CPU, RAM, non-rotating temporary storage means for storing data and a hard disk drive said method comprising the steps of:
intercepting calls to said disk drive by an agent and directing them to said non-rotating temporary storage when said disk drive is powered down, in which said agent means stores the contents of said temporary storage in said disk drive when said computer program is shut down.

16. An article according to claim 15, in which said agent copies temporary files generated by said program to said temporary storage.

17. An article according to claim 15, in which said agent is located in temporary non-rotating storage means other than RAM.

18. A method according to claim 15, in which said agent copies data to said temporary storage and thereafter directs commands to said hard disk drive to start and stop rotating, so that said hard disk drive is powered down and thereafter is rotated to store data under command of said agent only after an attempt to locate data in said temporary storage has failed.

19. An article according to claim 18, in which said agent copies temporary files generated by said program to said temporary storage.

20. An article according to claim 18, in which said agent is located in temporary non-rotating storage means other than RAM.

21. An article according to claim 15, in which said agent is located outside an operating system.
